(19) United States
(12) Patent Application Publication
(10) Pub. No.: US 2018/0331477 A1
(43) Pub. Date: Nov. 15, 2018

(54) ADAPTOR

(71) Applicant: Canare Electric Co., Ltd., Aichi (JP)

(72) Inventor: Satoshi KOMURO, Yokohama-shi (JP)

(73) Assignee: Canare Electric Co., Ltd.

(21) Appl. No.: 15/980,174

(22) Filed: May 15, 2018

(30) Foreign Application Priority Data
May 15, 2017 (JP) 2017-096159

(51) Int. Cl. H01R 24/54

(52) U.S. Cl. CPC H01R 24/545; H01R 2103/00; H01R 24/542

(57) ABSTRACT

An adaptor adequate for broadcast apparatuses required having high electrical performance and reliability achieves a reduced assembly length when a connector is connected to the adaptor body. In an adaptor, a cylindrical external contact of a first mating portion has an outer peripheral surface. A bottom surface that defines a lower end of the outer peripheral surface is located inside an adaptor body, and retracted from a top surface of one end of the adaptor body axially inward of the adaptor body. When a first connector mates with the first mating portion, the outer peripheral surface of the cylindrical external contact of the first mating portion engages with an inner peripheral surface of an external contact of a first connector.

This application claims foreign priority under 35 USC 119 based on Japanese Patent Application No. 2017-096159, filed on May 15, 2017, the contents of which is incorporated herein in its entirety by reference.

### TECHNICAL FIELD

The present invention relates to an adaptor, particularly to an adaptor for connecting two connectors to each other.

### BACKGROUND OF INVENTION

Adaptors in broadcast apparatuses or transmission apparatuses (hereafter may be simply referred to as “broadcast apparatuses”), are widely used, e.g., to connect cable wirings inside or outside an apparatus board (for example, Japanese Unexamined Patent Application Publication Hei 9-199240, Japanese Unexamined Patent Application Publication No. 2005-50752).

An adaptor disclosed in Japanese Unexamined Patent Application Publication Hei 9-199240 includes a pipe-shaped external conductor connection terminal whose each end is in sliding contact with an opposing external conductor of a coaxial connector to enable angular displacement and a center conductor connection terminal which is shaped in a pipe having a small diameter and whose each end is in sliding contact with an opposing center conductor of a coaxial connector to enable angular displacement. The external conductor connection terminal and center conductor connection terminal are coaxially located.

An adaptor disclosed in Japanese Unexamined Patent Application Publication No. 2005-50752 is an intermediate adaptor having a connection portion projecting from the body of the adaptor for connection to a coaxial cable. The adaptor has a center contact for center conductor connection. The center contact for center-conductor connection includes a connection-side contact connected to a coaxial cable, and a central-portion contact connected to the inner end of the connection-side contact. Each end of the center contact has a press-fit connection structure.

### SUMMARY OF INVENTION

### Technical Problems

Various broadcast apparatuses are being developed to meet 4K/8K broadcasting. As interface standards to connect between these broadcast apparatuses, a 3G-SDI (Serial Digital Interface) having a transmission rate of 3 Gb/s and a 12G-SDI having a transmission rate of 12 Gb/s are standardized. Wiring systems of apparatuses in these interface standards require high electrical performance and reliability. The development of adaptors that meet these requirements is being desired.

In the adaptor disclosed in Japanese Unexamined Patent Application Publication Hei 9-199240, the external conductor and center conductor of a coaxial connector have spherical slip surfaces. The slip surfaces mate with a pipe-shaped external conductor connection terminal and center conductor connection terminal. Therefore, the connection between the adaptor and coaxial connector is made in angularly-displaceable sliding contact between inner surfaces of the pipe-shaped conductors and spherical slip surfaces. This provides a restrictive contact. Thus, this contact is not necessarily appropriate for cable wiring of broadcast apparatuses required to have high electrical performance and reliability.

The adaptor disclosed in Japanese Unexamined Patent Application Publication Hei 9-199240 uses an elongated pipe-shaped external conductor connection terminal and a center conductor connection terminal that enable angularly-displaceable sliding contact. The adaptor disclosed in Japanese Unexamined Patent Application Publication No. 2005-50752 has the connection portion projecting from the adaptor body. When a connector is connected to the adaptor body, the assembly length is increased.

Except when a fixing mechanism between an adaptor and connector uses a bayonet locking mechanism or a threaded-fastening mechanism, a connector is generally rotatable relative to the mating axis of an adaptor. Therefore, particularly when a right angle connector plug having a mating portion tilted at a predetermined angle relative to the longitudinal direction of a cable mates with the mating portion of an adaptor, wear occurs due to the rotation on the contact portion between the contact of the adaptor and the contact of the connector plug to decrease electrical performance and reliability.

Therefore, one object of the present invention is to provide a technique capable of reducing an assembly length when a connector plug is connected to an adaptor body in an adaptor that is appropriate for cable wiring of broadcast apparatuses required to have high electrical performance and reliability.

An object of the present invention is, in an adaptor that is appropriate for cable wiring of a broadcast apparatus required to have high electrical performance and reliability, to provide a technique that prevents a connector plug from rotating at a contact portion between a contact of the adaptor and a contact of the connector plug.

### Solution

For addressing the above disadvantages, an adaptor of the present invention is configured to connect two connectors to each other. The adaptor includes an adaptor body, a center contact, and a cylindrical external contact. The adaptor body includes one end having a first mating portion for a first connector and the other end having a second mating portion for a second connector. The center contact extends between the first mating portion and second mating portion inside the adaptor body. The cylindrical external contact is provided to at least the first mating portion and located coaxially with the center contact. The cylindrical external contact of the first mating portion has a bottom surface that defines a lower end of an outer peripheral surface of the cylindrical external contact. The bottom surface is formed inside the adaptor body, and retracted from a top surface of the one end of the adaptor body axially inward of the adaptor body. When the first connector mates with the first mating portion, the outer peripheral surface of the cylindrical external contact of the first mating portion engages with an inner peripheral surface of an external contact of the first connector.

In a preferable embodiment of the adaptor of the present invention, the first mating portion and second mating portion of the adaptor body respectively may mate with the first connector and second connector that have different types.

In a preferable embodiment of the adaptor of the present invention, the first mating portion of the adaptor body may fit a right angle connector plug having a mating portion tilted by a predetermined angle relative to the longitudinal direction of a cable. It is clear in the art that the right angle connector plug includes an “L-shaped” connector plug having a connector body formed in an L shape.

In a preferable embodiment of the adaptor of the present invention, the top surface of the one end of the adaptor body has an uneven surface formed by radially arranging multiple projections or depressions. When the right angle connector plug mates with the first mating portion, one of the multiple projections or depressions may engage with a depression or projection provided to the connector plug body.

In a preferable embodiment of the adaptor of the present invention, the top end of the cylindrical external contact of the first mating portion may be located in the same surface as the top surface of the one end or located from the top surface inward or outward of the adaptor body.

Further, the adaptor of the present invention is an adaptor to connect two connectors to each other. The adaptor includes an adaptor body, a center contact, and a cylindrical external contact. The adaptor body includes one end having a first mating portion for a first connector and the other end having a second mating portion for a second connector. The center contact extends between the first and second mating portions inside the adaptor body. The cylindrical external contact is provided to at least the first mating portion and located coaxially with the center contact. When the first connector mates with the first mating portion, the outer peripheral surface of the cylindrical external contact of the first mating portion engages with an inner peripheral surface of an external contact of the first connector. Additionally, part or all of the engagement portion between the outer peripheral surface of the cylindrical external contact of the first mating portion and the inner peripheral surface of the external contact of the first connector is formed inside the adaptor body, and retracted from a top surface of the one end of the adaptor body axially inward of the adaptor body.

The adaptor of the present invention is configured to connect two connectors to each other. The adaptor includes an adaptor body having one end with a first mating portion and the other end with a second mating portion, a center contact extending between the first mating portion and second mating portion in the adaptor body, and a cylindrical external contact provided to at least the first mating portion and located coaxially with the center contact. The top surface of the one end of the adaptor body has an uneven surface formed by radially arranging multiple projections or depressions. When a right angle connector plug having a mating portion tilted by a predetermined angle relative to a longitudinal direction of a cable mates with the first mating portion, one of the multiple projections or depressions engages with a projection or depression provided to the body of the connector plug.

In an adaptor of the present invention, a bottom surface that defines a lower end of an outer peripheral surface of a cylindrical external contact of a first mating portion is formed inside the adaptor body, and retracted from a top surface of one end of an adaptor body axially inward of the adaptor body. Additionally, when a first connector mates with the first mating portion, the outer peripheral surface of the cylindrical external contact of the first mating portion engages with an inner peripheral surface of an external contact in a first connector. Alternatively, in the adaptor of the present invention, when the first connector mates with the first mating portion, the outer peripheral surface of the cylindrical external contact of the first mating portion engages with the inner peripheral surface of the external contact of the first connector. Part or all of the engagement portion between the outer peripheral surface of the cylindrical external contact of the first mating portion and the inner peripheral surface of the external contact of the first connector is formed inside the adaptor body, and retracted from the top surface of one end of the adaptor body axially inward of the adaptor body. Therefore, the adaptor of the present invention can obtain electrical performance and reliability and a short assembly length.

In the adaptor of the present invention, the top surface of the one end of the adaptor body has an uneven surface formed by radially arranging multiple projections or depressions. When a right angle connector plug mates with the first mating portion, one of the multiple projections or depressions engages with a depression or projection provided to the body of the connector plug. This achieves the adaptor that enables the connector plug to be secured to an appropriate position of the top surface and to be effectively prevented from rotating at the contact portion between the contact of the adaptor and the contact of the connector plug.

The above and other objects and advantages of the present invention are more clearly understood through explanation of the following embodiments. The following embodiments are examples. These do not limit the present invention.

### BRIEF DESCRIPTION OF DRAWINGS

FIG. 1 is a sectional view of an example of an adaptor;

FIG. 2 is a sectional view of an example of a connector plug;

FIG. 3 is a perspective view of the adaptor and connector before mating;

FIG. 4 is a sectional view of the adaptor and connector plug after mating;

FIG. 5 is a perspective view of the adaptor and connector plug after mating;

FIG. 6 is a perspective view of a comparative example of an adaptor and the connector plug before mating;

FIG. 7 is a perspective view of the comparative example of the adaptor and the connector plug after mating;

FIG. 8 is a perspective view of another example of an adaptor and another example of a connector plug before mating.

### DESCRIPTION OF EMBODIMENTS

Preferred embodiments of an adaptor of the present invention are described below in detail based on the appended drawings.

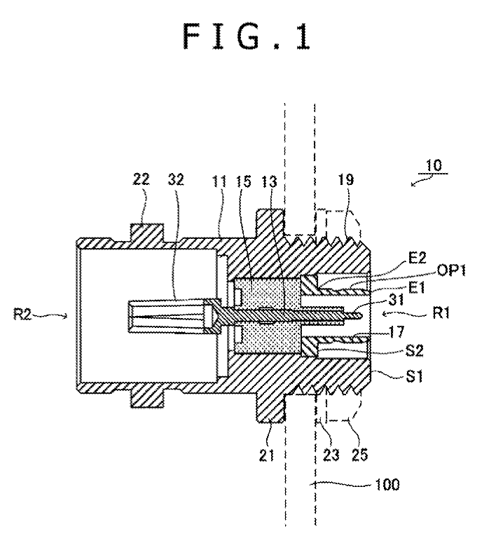

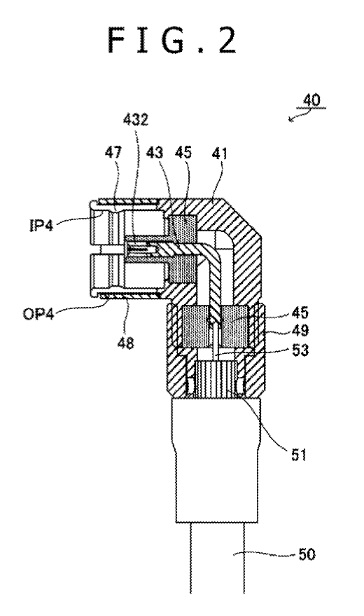

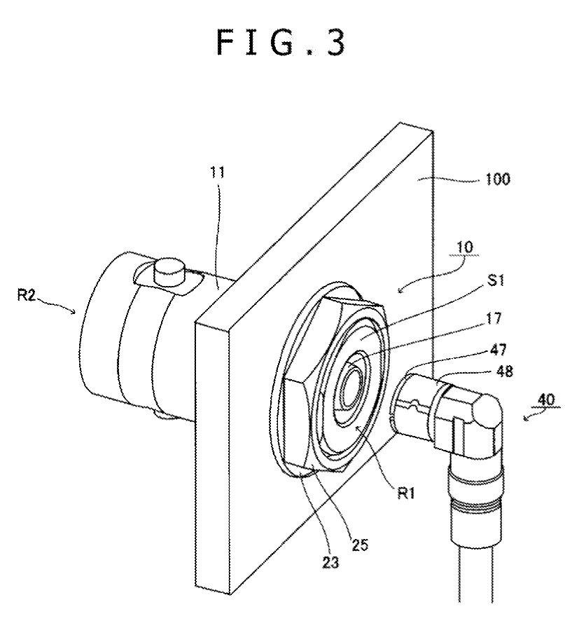

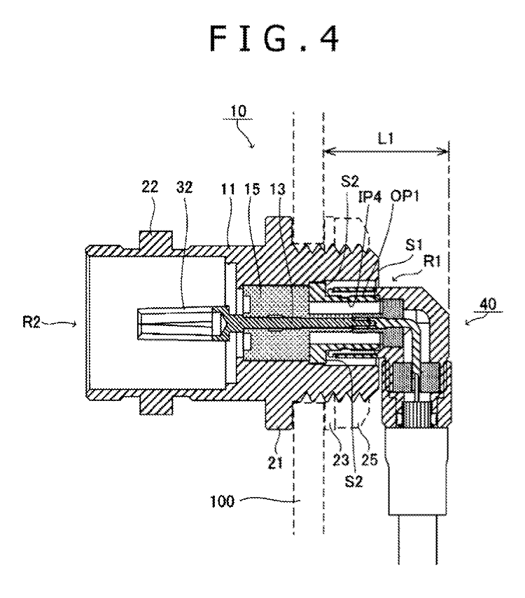

FIG. 1 is a cross section of an example of an adaptor to which the present invention is applied. FIG. 2 is a cross section of an example of a connector plug mating with the adaptor. FIG. 3 is a perspective view of the adaptor and connector plug before mating. FIG. 4 is a perspective view of the adaptor and connector after mating.

The adaptor of the present embodiment described below is an example in which the present invention is applied to a conversion adaptor. The adaptor has one end mating with a right angle connector plug compliant with a 12G-SDI standard and the other end mating with a BNC connector plug. The combination of the two mating connectors is an example. This does not limit the present invention.

Referring to FIG. 1, an adaptor 10 includes a connector body 11, a center contact 13, and a cylindrical external contact 17. One end of the adaptor body 11 has a plug mating portion R1 (corresponding to a first mating portion) for a right angle connector plug of a 12 G-SDI standard. The other end of the adaptor body 11 has a plug mating portion R2 (corresponding to a second mating portion) for a BCN connector plug. The center contact 13 extends between the plug mating portion R1 and plug mating portion R2 inside the adaptor body 11. The cylindrical external contact 17 is located at least to the plug mating portion R1 coaxially with the center contact 13.

The outer periphery of the adaptor body 11 has a thread portion 19 and a flange 21 toward the plug mating portion R1. The outer periphery of the adaptor body 11 has a projection 22 for a bayonet locking mechanism toward the plug mating portion R2. The adaptor body 11 penetrates a hole provided to a panel 100 of a broadcast apparatus, and is secured between the flange 21 and a threaded-fastening mechanism including a washer 23 and a nut 25 to sandwich the panel 100.

The center contact 13 is supported relative to and electrically insulated from the adaptor body 11 and cylindrical external contact 17 by an insulator 15. The center contact 13 has a male contact portion 31 toward the plug mating portion R1 and a female contact portion 32 toward the plug mating portion R2.

The cylindrical external contact 17 of the plug mating portion R1 has a bottom surface S2 formed inside the adaptor body 11 and retracted from a top surface S1 of one end of the adaptor body 11 axially inward of the adaptor body 11. The bottom surface S2 defines a lower end E2 of an outer peripheral surface OP1 of the cylindrical external contact 17. When a connector plug 40 in FIG. 2 mates with the plug mating portion R1, the outer peripheral surface OP1 of the cylindrical external contact 17 of the plug mating portion R1 engages with an inner peripheral surface IP4 of an external contact 47 of the connector plug 40. FIG. 1 illustrates an example in which a top end E1 of the cylindrical external contact 17 is located in the same plane as the top surface S1. The top end E1 may be located from the top surface S1 inward of the adaptor body 11.

Referring to FIG. 2, the connector plug 40 is a right angle connector plug mating with the mating portion R1 of one end of the adaptor body 11. The connector plug 40 includes a plug body 41 formed in an L shape, a center contact 43, an insulator 45 that supports and electrically insulates the center contact 43 relative to and from the plug body 41, and the external contact 47 toward the top end of the plug body 41.

The center contact 43 of the connector plug 40 is formed in an L type, and has an end electrically connected to a center conductor 53 of a cable 50. The other end of the center contact 43 has a female contact portion.

The external contact 47 of the connector plug 40 has a flat spring 48 to wind and tighten an outer peripheral surface OP4 divided into four.

The rear end side of the plug body 41 of the connector plug 40 has a clamping nut 49. The clamping nut 49 enables clamping of the end portion of the cable 50 to the rear end of the plug body 41, while maintaining the electrical connection between one end of the center contact 43 and the center conductor 53 of the cable 50, and the electrical connection between the plug body 41 and an external conductor 51 of the cable. Such clamping on the rear end side of the connector plug 40 does not relate to the mating of the adaptor body 11 with the plug mating portion R1. This clamping does not limit the structure of the adaptor of the present invention.

Referring to FIGS. 1, 2, and 4, when the connector plug 40 mates with the plug mating portion R1 of the adaptor body 11, the male contact portion 31 of the center contact 13 of the plug mating portion R1 mates with a female contact 432 of the center contact 43 of connector plug 40.

When the connector plug 40 mates with the plug mating portion R1 of the adaptor body 11, the outer peripheral surface OP1 of the cylindrical external contact 17 of the plug mating portion R1 engages with the inner peripheral surface IP4 of the external contact 47 of the connector plug 40. Specifically, while the projection on the inner peripheral surface IP4 of the external contact 47 of the connector plug 40 interlocks with the depression on the outer peripheral surface OP1 of the cylindrical external contact 17 of the plug mating portion R1, the inner peripheral surface IP4 of the external contact 47 of the connector plug 40 is in contact with and engages with the outer peripheral surface OP1 of the cylindrical external contact 17 of the plug mating portion R1. The elastic force of the flat spring 48 about the external contact 47 of the connector plug 40 is useful to hold this engagement.

Thus, when the connector plug 40 mates with the plug mating portion R1 of the adaptor body 11, the outer peripheral surface OP1 of the cylindrical external contact 17 of the plug mating portion R1 engages and are in contact with the inner peripheral surface IP4 of the external contact 47 of the connector plug 40. High electrical performance and reliability can be therefore ensured in combination with the mating between the male contact portion 31 of the center contact 13 of the plug mating portion R1 and the female contact 432 of the center contact 43 of the connector plug 40.

Additionally, all of the engagement portion between the outer peripheral surface OP1 of the cylindrical external contact 17 of the plug mating portion R1 and the inner peripheral surface IP4 of the external contact 47 of the connector plug 40 is retracted inward of the adaptor body 11 (between the top surface S1 and bottom surface S2). The assembly length of the adaptor 10 and connector plug 40 can be reduced by the length of the retracted engagement portion.

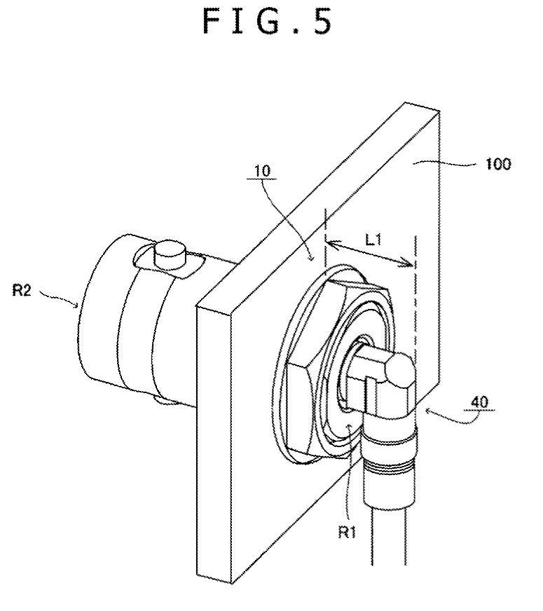

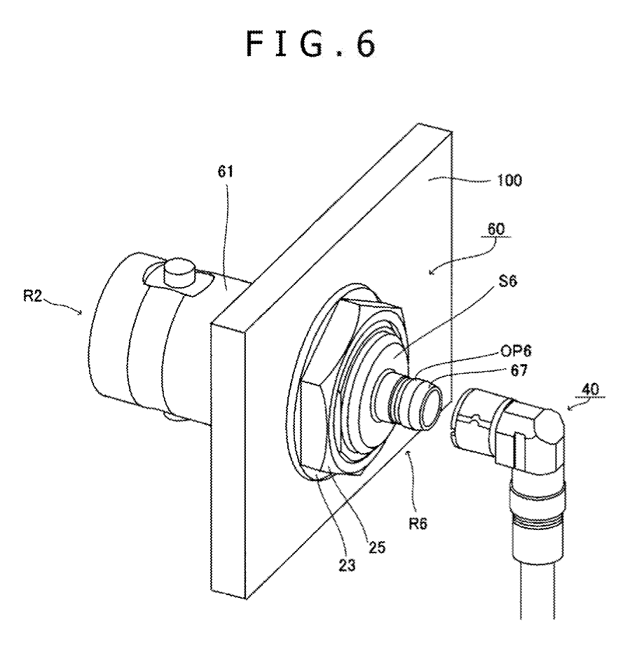

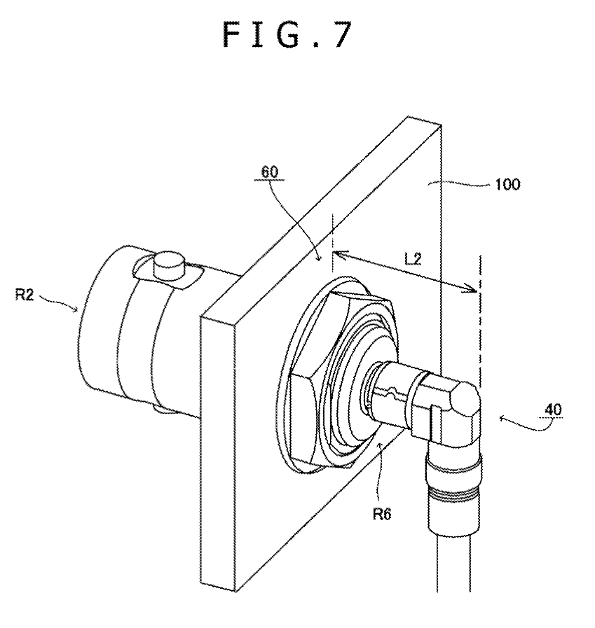

Referring to FIGS. 4 and 5, a distance from the panel 100 to the back of the connector plug 40 is set as L1 in the adaptor 10 of the present embodiment when the connector plug 40 mates with the plug mating portion R1 of the adaptor body 11. Referring to FIGS. 6 and 7, in a comparative example of an adaptor 60 (as in FIG. 6, an adaptor body 61 has a plug mating portion R6 as one end having an external contact 67 extending axially outward from a top surface S6), a distance from the panel 100 to the back of the connector plug 40 is set as L2 when the connector plug 40 mates with the plug mating portion R6 of the adaptor body 61. When compared to each other, L1 is significantly shorter than L2 by the length of the engagement portion retracted inward of the adaptor body 11.

Even when the engagement portion between the outer peripheral surface OP1 of the cylindrical external contact 17 of the plug mating portion R1 and the inner peripheral surface IP4 of the external contact 47 of the connector plug 40 is partially retracted inward of the adaptor body 11, the length of the assembly can be reduced by the length of the partially retracted portion.

As in FIGS. 4 and 5, the right angle connector plug 40 is rotatable relative to the mating axis of the adaptor 10. Therefore, when the connector plug mates with the mating portion of the adaptor, abrasion may occur due to the rotation in the contact portion between the outer peripheral surface OP1 of the external contact of the adaptor 10 and the inner peripheral surface IP4 of the external contact of the connector plug 40 to affect the electrical performance and reliability. Another example of an adaptor and another example of a connector plug are described below to address the situation.

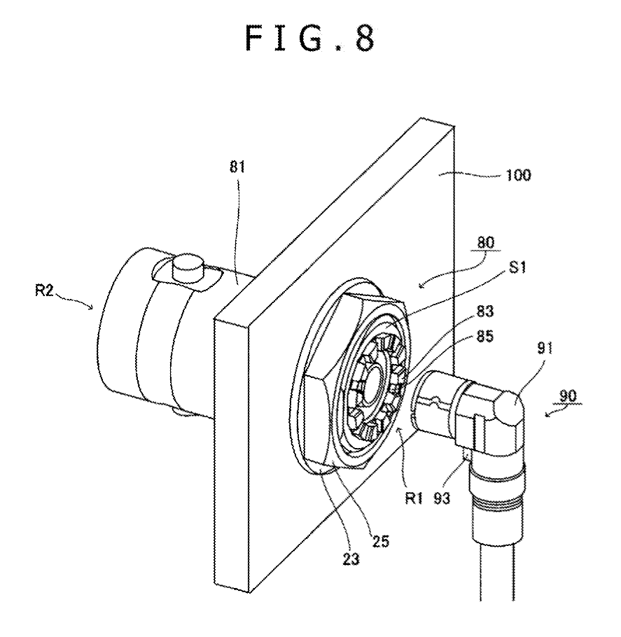

FIG. 8 is a perspective view of another example of an adaptor and another example of a connector plug. These adaptor and connector plug are in a pre-mating state. The adaptor and connector plug shown in FIG. 8 are different from the adaptor 10 and connector plug 40 in the pre-mating state shown in FIG. 3. The differences are that an adaptor 80 in FIG. 8 particularly includes the top surface S1 that is one end of an adaptor body 81 and that has an uneven surface formed by radially arranging multiple projections 83 or multiple depressions 85. Additionally, a plug body 91 of a right angle connector plug 90 includes, toward the cable, a projection 93 oriented in the substantially same direction as the mating portion. When the right angle connector plug 90 mates with the first mating portion R1, one of the multiple depressions 85 on the top surface S1 engages with the projection 93 provided to the plug body 91 of the connector plug 90. Therefore, the connector plug 90 can be secured to an appropriate position of the top surface S1. Additionally, the connector plug can be effectively prevented from rotating at the contact portion between the outer peripheral surface OP1 of the external contact of the adaptor 80 and the inner peripheral surface IP4 of the external contact of the connector plug 40.

The plug body 91 of the right angle connector plug 90 is provided with the projection 93 as one example. A depression can be provided instead of the projection. When the connector plug 90 mates with the first mating portion R1, one of the multiple projections on the top surface S1 may engage with the depression of the plug body 91 of the connector plug.

The adaptor of the present invention is effective particularly when a connector plug needs to be connected to have a low height at input terminals or output terminals of various apparatuses that use transmission lines to transmit signals and power (including broadcast apparatuses, video and audio apparatuses, signal transmitters, signal receivers, and relay apparatuses, etc.).

The present invention is widely applicable to adaptors for connecting two connectors to each other.

What is claimed is:

1. An adaptor to connect two connectors to each other, the adaptor comprising:
an adaptor body including one end having a first mating portion for a first connector and the other end having a second mating portion for a second connector;
a center contact extending between the first mating portion and the second mating portion inside the adaptor body; and
a cylindrical external contact provided to at least the first mating portion and located coaxially with the center contact,
wherein a bottom surface that defines a lower end of an outer peripheral surface of the cylindrical external contact of the first mating portion is formed to be inside the adaptor body and to be retracted from a top surface of the one end of the adaptor body axially inward of the adaptor body, and
when the first connector mates with the first mating portion, the outer peripheral surface of the cylindrical external contact of the first mating portion engages with an inner peripheral surface of an external contact of the first connector.

2. The adaptor according to claim 1, wherein the first mating portion and second mating portion of the adaptor body respectively mate with the first connector and second connector that have different types.

3. The adaptor according to claim 1, wherein the first mating portion of the adaptor body fits a right angle connector plug having a mating portion tilted at a predetermined angle relative to a longitudinal direction of a cable.

4. The adaptor according to claim 3, wherein the top surface of the one end of the adaptor body has an uneven surface formed by radially arranging a plurality of projections or depressions, and
when the right angle connector plug mates with the first mating portion, one of the plurality of projections or depressions engages with a depression or projection provided to the body of the connector plug.

5. The adaptor according to claim 1, wherein a top end of the external contact of the first mating portion is located in an identical plane to the top surface of the one end or located from the top surface inward or outward of the adaptor body.

6. An adaptor to connect two connectors to each other, the adaptor comprising:
an adaptor body including one end having a first mating portion for a first connector and the other end having a second mating portion for a second connector;
a center contact extending between the first mating portion and the second mating portion inside the adaptor body; and
a cylindrical external contact provided to at least the first mating portion and located coaxially with the center contact,
wherein the outer peripheral surface of the cylindrical external contact of the first mating portion engages with an inner peripheral surface of the external contact of the first connector when the first connector mates with the first mating portion, and
part or all of an engagement portion between the outer peripheral surface of the cylindrical external contact of the first mating portion and the inner peripheral surface of the external contact is formed inside the adaptor body, and retracted from the top surface of the one end of the adaptor body axially inward of the adaptor body.

7. The adaptor according to claim 6, wherein the first mating portion and second mating portion of the adaptor body may respectively mate with the first connector and second connector that have different types.

8. The adaptor according to claim 6, wherein the first mating portion of the adaptor body fits a right angle connector plug having a mating portion tilted at a predetermined angle relative to a longitudinal direction of a cable.

9. The adaptor according to claim 8, wherein the top surface of the one end of the adaptor body has an uneven surface formed by radially arranging a plurality of projections or depressions, and
when the right angle connector plug mates with the first mating portion, one of the plurality of projections or depressions engages with a depression or projection provided to the body of the connector plug.

10. The adaptor according to claim 6, wherein a top end of the external contact of the first mating portion is located in an identical plane to the top surface of the one end or located from the top surface inward or outward of the adaptor body.
